(19) United States
(12) Patent Application Publication
(10) Pub. No.: US 2014/0129348 A1
(43) Pub. Date: May 8, 2014

(54) SYSTEM FOR TARGETED ADVERTISING

(71) Applicant: EOVENDO ApS, Brabrand (DK)

(72) Inventors: Nicolas Waldorff Hyltoft Ibenforth, Helsingor (DK); Martin Østergaard, Aabybro (DK)

(73) Assignee: EOVENDO ApS, Brabrand (DK)

(21) Appl. No.: 14/151,163

(22) Filed: Jan. 9, 2014

Related U.S. Application Data
(63) Continuation of application No. 13/055,674, filed on Mar. 25, 2011.
Application No. 13/055,674 is a continuation-in-part of application No. 12/182,529, filed on Jul. 30, 2008.

(51) Int. Cl. G06Q 30/02

(52) U.S. Cl. CPC G06Q 30/0269
USPC 705/14.66

(57) ABSTRACT

The system comprises a client computing device having Internet connectivity and at least one display, a browser adapted to run on said client computing device for accessing content on Internet, an advertising software adapted to run on said client computing device for accessing advertisements and comprising means for obtaining information about user-relevant categories of advertisements, and means for down loading image advertisements according to user-relevant categories. The advertising software is adapted to display an image advertisement on the display, comprises means for detecting a triggering event initiated by the user activating a user input interface of the client computing device, allows the user to choose whether or not to display an advertisement downloaded upon detection of the triggering event. If the user has chosen to display an advertisement downloaded, the advertising software is adapted to at least temporarily block access to content on a communication network while displaying one advertisement.

### CROSS-REFERENCE TO RELATED APPLICATIONS

This application is a continuation of U.S. application Ser. No. 13/055,674, filed on Mar. 25, 2011, which claims the benefit and priority to and is a U.S. National Phase Application of PCT International Application Number PCT/DK2009/050192, filed on Jul. 30, 2009, designating the United States of America and published in the English language, which is an International Application of, a continuation-in-part of, and claims the benefit of priority to U.S. application Ser. No. 12/182,529, filed on Jul. 30, 2008. The disclosures of the above-referenced applications are hereby expressly incorporated by reference in their entireties.

### FIELD OF THE INVENTION

The present invention relates to a system for targeted advertising using computers connected to the Internet, in particular advertisements with images.

### BACKGROUND OF THE INVENTION

In advertising products and services, advertisers have always had an interest in targeted advertising, that is to say finding a way of getting the advertising message to those who are actually potential costumers, and not wasting effort and resources on those who have no need for or interest in the products or services. With the advent personal computers connected to the Internet, and people retrieving information via the World Wide Web, such targeted advertising has become increasingly possible as compared to traditional broadcast media, public posters, etc. In addition to this, and perhaps more even more important, it has become possible to track to some degree, who actually takes an interest in the advertising message.

Apart from that, different types of advertisements have different value in general. That is to say the advertising value of a small printed advertisement is far less than e.g. a 30 second moving image advertisement. This is also reflected in the effort put into the production of moving image advertisements, some of which are both well directed and entertaining to a degree, where viewers take a pleasure in watching them.

Now, when advertisements are properly targeted to the user, their value increases even further, because fewer resources are wasted on non-potential costumers. Taking this one step further means that if a potential costumer by indicating the user's specific interest in certain products or services, it may even be worthwhile for the advertiser to pay the costumer to watch the advertisements.

If the user is to have a proper economical benefit from watching the advertisements, the advertisements will have to be the ones with the highest value, i.e. moving image advertisements, e.g. of a duration of 30 seconds as indicated above.

In US 2002/0032906 it is suggested to remunerate the viewer for watching moving image advertisements.

However simply remunerating the consumer to watch the advertisements is not necessarily sufficient to gain the user's acceptance. In fact, watching advertisements is only interesting for the consumer if the remuneration the user receives is in a reasonable relationship the effort the user has to put into it. That is to say that the consumer should not have to invest much effort in installing the parts of the system, i.e. the programs, the user needs on the user's computer, the user should not have to deal with complicated procedures when starting and running the program, the user should not be facing any annoying delays, where the user might feel that the user wastes the user's time. The consumer should have an easy way of accessing the program falling naturally into the user's normal routines when the user uses the user's computer.

On the other hand, if the advertiser is to remunerate the consumer for watching the advertisements, the user has to make certain that the consumer actually watches the advertisements. Thus, some kind of user activity for verification is needed in order to verify that the advertisement has actually been watched.

### SUMMARY OF THE INVENTION

The present invention provides a system for advertising based on user-relevant categories of advertisements, said system comprising a client computing device having electronic communication network connectivity and at least one display for visual output from the computing device, a browser constituting part of said system and adapted to run on said client computing device for accessing content on a communication network, an advertising software constituting part of said system and adapted to run on said client computing device for accessing advertisements, said advertising software comprising means for obtaining information about user-relevant categories of advertisements, said advertising software comprising means for downloading multimedia files comprising image advertisements in accordance with said user-relevant categories, said advertising software being adapted to display at least one of said multimedia files as image advertisements on the display, wherein said advertising software furthermore comprises means for detecting a triggering event initiated by the user activating a user input interface of the client computing device, said advertising software allowing the user to choose whether or not to display at least one of the image advertisements downloaded, upon detection of the triggering event, and with the proviso that the user, after having been allowed to choose, has chosen to display at least at least one of the image advertisements downloaded, said advertising software being adapted to at least temporarily block access to content on a communication network as long as it is displaying said at least one multimedia file.

A system allowing the user to choose whether or not to display at least one image advertisement downloaded may have the effect that the advertiser is certain that the user is offered the possibility of watching advertisements while at the same time the user still has control at any time over what the computing device displays.

In a possible embodiment of the system, the invention provides a system for targeted advertising, said system comprising a client computing device having Internet connectivity and at least one display screen, a browser software adapted to run on said client computing device for accessing World Wide Web content, an advertising software adapted to run on said client computing device, said advertising software allowing the user to indicate preferred categories of advertisements, said advertising software comprising means for downloading multimedia files comprising image advertisements in according with said preferred categories, said advertising software being adapted to display said multimedia files as image advertisements on the screen, wherein said advertising software is adapted to at least temporarily block access to World Wide Web content as long as it is running. The image advertisements may be still image or moving image advertisements or a combination of both images. Subsequently to displaying the multimedia files, the user is then automatically directed to the World Wide Web.

According to an aspect of the invention, said advertising software is adapted to block access for said computing device to said browser. Thereby, the user is prompted to choose to display the advertisement on the computing device.

According to another aspect of the invention, said triggering event is a start of said browser on the computing device. The triggering event for at least allowing the user whether to display the advertisement or not may result in the advertisements often being displayed, considering that starting a browser on a computing device is an event that happens often on a computing device.

According to another aspect of the invention, said triggering event is a start of said advertising software on the computing device. If one choice of the user is to start running the advertisement software, the result is that at least one advertisement will be displayed on the computing device.

According to another aspect of the invention, said advertising software allowing the user to choose to display at least one of the image advertisements downloaded amongst advertisements most recently downloaded, upon detection of the triggering event. The choice resulting in different possibilities of viewing advertisements may result in the advertisements often being displayed, considering that the user may choose among different advertisements being grouped based on different characteristics of the advertisements.

According to another aspect of the invention, said advertising software allowing the user to choose to display at least one of the image advertisements downloaded amongst the advertisements being rated as the best by a plurality of users, upon detection of the triggering event. If one choice of the user is to start running the advertisement software for displaying at least one advertisement being characterized as the best, the result is that at least one advertisement will be displayed on the computing device.

According to another aspect of the invention, said advertising software allowing the user to choose to display at least one of the image advertisements downloaded amongst the advertisements the most viewed by a plurality of users, upon detection of the triggering event. If one choice of the user is to start running the advertisement software for displaying at least one advertisement being characterized as the most viewed, the result is that at least one advertisement will be displayed on the computing device.

According to an aspect of the invention, said advertising software is adapted to upload the downloaded multimedia files to other client computing devices. Uploading multimedia files from other client computing devices may result in a faster and/or a safer and/or an easier and/or a better access to multimedia files than from a centralized server.

According to an aspect of the invention, said software comprises means for registering information about the upload of multimedia files, means for communicating said information to a server, said server comprising means for effecting remuneration of a person identified as the user of the software. Remuneration of the user of the software may result in user being more prone to choosing to display one or more advertisement on the client computing device.

According to an aspect of the invention, said advertising software further comprises a mailbox adapted for receiving and displaying electronic advertisement brochures. The advertisement software comprising such mailbox may result in the user being provided with more choices for displaying advertisements, and may result in advertisers being more prone to using the system according to the invention.

According to an aspect of the invention, at least one still image advertisements is downloaded and subsequently displayed during the download of at least one moving image advertisement to be displayed. Downloading moving image advertisements may take more time than downloading still image advertisements. By displaying still image advertisements during download of moving image advertisements, the result may be that the user will not experience, or at least the user will experience only very little, delay between choosing to display moving image advertisements and the moving image advertisements being displayed.

According to an aspect of the invention, none of the still image advertisements are displayed until all the still image advertisements have been downloaded. With such an embodiment, the result may be that the display duration of still image advertisements is equal for each still image advertisement.

According to an aspect of the invention, said advertising software displays said multimedia files as image advertisements on the screen in a temporal sequence, the displaying of the next image advertisement being contingent to user input action within a certain time limit after the preceding image advertisement is finished. With such an embodiment, the result may be that the advertising software allows registering that the user has actually viewed the advertisement.

According to an aspect of the invention, the system has means for allowing only a predetermined number of image advertisements to be displayed within a given time period. With such an embodiment, the result may be that the advertising software allows to limit the duration of display of the advertisement and to increase the variety of the advertisement offered to display in order to make sure that the user watches the advertisement.

According to an aspect of the invention, said software comprises control means for confirming that the user has viewed the image advertisement. With such an embodiment, the result may be that the advertising software registers that the user has actually viewed the advertisement.

According to an aspect of the invention, said control means comprises

at least one user feedback element displayed on the visual output and to be activated by the user within a certain time limit after the display of the image advertisement is finished to confirm the user's viewing of the image advertisement; and

means for pseudo-randomly placing the at least one user feedback element on the visual output at the end of the display of an image advertisement. With such an embodiment, the result may be that the advertising software counterstrikes malicious users that try to cheat the advertising system.

According to an aspect of the invention, said advertising software comprises means for offering to redirect the user to a website corresponding to the at least one viewed image advertisement. With such an embodiment, the result may be that the advertising software offers a better provisioning of the service for the user to access websites related to the advertisement viewed. This way, the user does not have spend time looking for the website related to the specific advertisement viewed.

According to an aspect of the invention, said advertising software comprises means for registering information about the display of said image advertisements, including confirmation of the user's viewing of said image advertisements, means for communicating said information to a server, said server comprising means for effecting remuneration of a person identified as the user of the software. With such an embodiment, the result may be that the advertising software allows to register information of the user's viewing and to increase the number of advertisement views.

According to an aspect of the invention, said advertising software comprises means for allowing the user to convert the remuneration into at least one of the following financial contributions: a service offered by a service provider to the user, a donation offered by the user to others. With such an embodiment, the result may be that the advertising software allows the user to choose different types of remuneration.

According to an aspect of the invention, the computing device is selected from the group of a personal computer, a gaming console, a personal digital assistant, a cellular phone. With such an embodiment, the result may be the portability of the invention to several platforms.

In a further aspect, the invention provides a method of advertising based on user-relevant categories of advertisements, said method comprising:

obtaining information about user-relevant categories of advertisements,

downloading at least one multimedia file comprising at least one image advertisement in accordance with said user-relevant categories,

detecting a triggering event initiated by the user activating a user input interface of the client computing device,

upon detection of the triggering event, allowing the user to choose whether or not to display the at least one image advertisement downloaded,

displaying on visual output the at least one of image advertisement if the user has chosen the at least one image advertisement to be displayed,

temporarily blocking access to content on a communication network as long as the at least one image advertisement is displayed.

According to an aspect of the invention, a starting said browser on the computing device triggers the event to be detected for allowing the user to choose whether or not to display the at least one image advertisement ready to be displayed. The triggering event for at least allowing the user whether to display the advertisement or not may result in the advertisements often being displayed, considering that starting a browser on a computing device is an event that happens often on a computing device.

According to an aspect of the invention, access to said browser is blocked, when the triggering event is detected. Thereby, the user is prompted to choose to display the advertisement on the computing device.

According to an aspect of the invention, downloading a number of still image advertisements is performed during the download of the first moving image advertisement and then subsequently displaying of the downloaded still image advertisements is performed. By displaying still image advertisements during download of moving image advertisements, the result may be that the user will not experience, or at least the user will experience only very little delay between choosing to display moving image advertisements and the moving image advertisements being displayed.

According to an aspect of the invention, displaying of the still image advertisements is not performed until all the still image advertisements have been downloaded. With such an embodiment, the result may be that the display duration of still image advertisements is equal for each still image advertisement.

According to an aspect of the invention, displaying said multimedia files as image advertisements is performed in a temporal sequence, the displaying of the next image advertisement being contingent to user input action within a certain time limit after the preceding image advertisement is finished. Such an embodiment results in registering that the user has actually viewed the advertisement.

According to an aspect of the invention, displaying a predetermined number of image advertisements only is performed within a given time period. Such an embodiment may result in limiting the duration of display of the advertisement and increasing the variety of the advertisement offered to display in order to make sure that the user watches the advertisement.

According to an aspect of the invention, confirming that the user has viewed the image advertisement is performed. Such an embodiment may result in the possibility of registering that the user has actually viewed the advertisement.

According to an aspect of the invention, the method comprises placing pseudo-randomly at least one user feedback on the visual output, and the user activates the at least one user feedback element, at the end of the display of an image advertisement within a certain time limit after the display of the image advertisement is finished, with said feedback element registering the user's viewing of the image advertisement. Such an embodiment may result in counterstriking malicious users that try to cheat the advertising system.

According to an aspect of the invention, the method comprises redirecting the user to a website corresponding to the at least one viewed image advertisement. Such an embodiment may result in a better provisioning of the service for the user to access websites related to the advertisement viewed. This way, the user does not have spend time looking for the website related to the specific advertisement viewed.

According to an aspect of the invention, the method comprises registering information about the display of said image advertisements, said information including confirmation of the user's viewing of said image advertisements, and wherein said information is communicated to a server, said server effecting remuneration for viewing the advertisements of a person identified as the user of the software. Such an embodiment may result in monitoring the user's views and increasing the number of advertisement views.

According to an aspect of the invention, the method comprises converting the remuneration into at least one of the following financial contributions: a service offered by a service provider to the user, a donation offered by the user to others. Such an embodiment may result in allowing the user to choose different types of remuneration.

In a further aspect, the invention provides a system for advertisers to display advertisements on a visual output of a client computing device to a user of the client computing device, said system comprising:

the client computing device having network connectivity and at least one display for visual output from the computing device,

a browser software constituting part of said system and adapted to run on said client computing device for accessing content on a communication network,

a server device having network connectivity and accessible from a communication network,

an advertiser software constituting part of said system and adapted to run on said server device,

said advertiser software allowing an advertiser to upload at least one multimedia file comprising image advertisements,

said advertiser software allowing an advertiser to indicate at least one category of the uploaded image advertisement,

said advertiser software allowing an advertiser to select demographics and location information of targeted viewers,

said advertiser software allowing an advertiser to enter a timing for uploaded advertisement to be distributed to targeted viewers, and

said advertiser software providing an advertiser with statistical information related to viewers of the uploaded image advertisement. With such an embodiment, the result may be providing advertisers with a system to monitor configure and control their advertising campaigns in real-time.

According to an aspect of the invention, the demographics of targeted viewers comprise age, age range, gender, personal status, financial capability, and profession. With such an embodiment, the result may be that the advertiser system allows to configure an advertising campaign and to implement the configuration adjustments in real-time with almost no time delay.

According to an aspect of the invention, the location information of targeted viewers comprises country, region, and postal code. With such an embodiment, the result may be that the advertiser system allows to configure an advertising campaign and to implement the configuration adjustments in real-time with almost no time delay.

According to an aspect of the invention, the timing for uploaded advertisement to be distributed to targeted viewers is a lifetime period, a priority of distribution over the said period, a distribution frequency per time unit of the said period and any combination thereof. With such an embodiment, the result may be that the advertiser system allows to configure an advertising campaign and to implement the configuration and adjustments in real-time with almost no time delay.

According to an aspect of the invention, the statistical information related to viewers of the uploaded image advertisement comprises number of views, number of viewer clicks, a metric relating the number of views to the number of clicks, and geographical information of the viewers. With such an embodiment, the result may be that the advertiser system allows to monitor an advertising campaign in real-time.

### BRIEF DESCRIPTION OF THE DRAWINGS

Examples of the invention will now be explained below with reference to the very schematic drawings, in which:

FIG. 1 depicts client computers connected to a server via the Internet.

FIG. 2 is a flowchart illustrating the operation of the program during active use.

FIG. 3 is an example illustrating the display of logos on the graphical user interface.

FIG. 4 is an example illustrating the display of an image advertisement.

FIG. 5 is an example illustrating the display of interactive buttons after the display of an image advertisement.

FIG. 6 shows the display of options and closing page with interactive buttons.

FIG. 7 shows the display of categories of advertisements to be selected by the user.

FIG. 8 shows the display of further options related to categories of advertisements to be selected by the user.

FIG. 9 shows the display of frequency options related to categories of advertisements to be selected by the user.

FIG. 10 shows the display of the mailbox comprised in the advertising software for receiving electronic advertisement brochures.

FIG. 11 is a diagram illustrating the workflow of registration in a simplified manner.

FIG. 12 is a flowchart illustrating the operation of the program when triggered by the detection of an event.

### DETAILED DESCRIPTION OF THE INVENTION

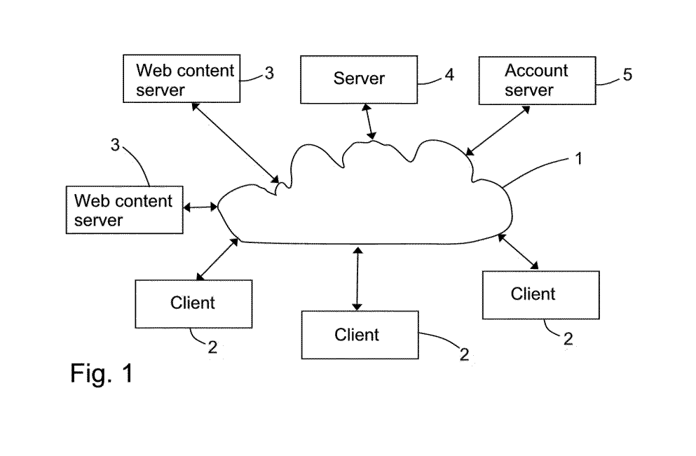

FIG. 1 shows a number of computers being interconnected via the Internet 1 so as to allow them to communicate with each others. The details of this are well known for the person skilled in the art and will not be dealt with. Via a electronic communication network such as the Internet a number of client computers 2, such as personal computers used at home or at work may connect access World Wide Web content from a number of computers operating as web content servers 3 for providing web content, such as news, shopping services, etc. It should, however, be noted that the invention is not restricted to general purpose personal computers, rather any computing device with multimedia capability and sufficient Internet connectivity or other electronic communication network connectivity, such as a gaming console, a personal digital assistant, a television or a cellular phone may constitute the client computer 2. In the remainder of the detailed description, the Internet will be used as an example of an communication network.

Typically, the user of the client computer 2 uses a client program such as a browser running on the computer 2 for accessing web content. For administrating the targeted advertising according to the present invention a server 4 is also connected to the Internet 1. For administrating the remunerations involved in the present a third party account server 5 may also be connected to the Internet 1.

The general idea of the present invention is to prevent access from a client computer 2 to the web content servers until the user of the client computer has watched a number of advertisements for which the user is remunerated, or decided that the user does not want to be remunerated and actively decides not to watch the advertisements. It should in this respect in particular be noted that it is not the intention to restrict the user's access to the Internet as such. Such a restriction, which would prevent the user from checking the user's email, updating the user's antivirus patterns, the user's operating system etc. would hardly find acceptance among users in general.

For this, a program, in the following referred to as the advertising software, is installed on the client computer 2. The advertising software may be a separate program via which the user launches the user's browser or it may be a plug-in which automatically starts up when the user launches the user's browser or it may even be an integrated part of a specifically adapted browser.

The advertising software comprises means for user to indicate preferred categories of advertisements. Information about these preferred categories may be stored locally on the client computer 2 and/or externally on a server, e.g. the server 4. The advertising software further comprises means for downloading multimedia files, in particular image advertisements in accordance with the preferred categories. As used herein the term “image advertisement” refers to any advertisement involving an image, it may be still image advertisement or moving image advertisement. The term “session” refers to a plurality of advertisement arranged in a sequence to be displayed to the user. A session is created for a certain user based on user preferences, censorship, campaign demands in terms of views and time frame, whether the user fulfils the targeted criteria of the campaign.

The download of multimedia files may be provided directly from a central sever, e.g. the server 4 or it may, as is presently preferred, be downloaded from distributed locations. The advertising software is also adapted to display said multimedia files as moving image advertisements on the screen, so as to allow the user to watch them. In principle the multimedia files may be in any appropriate format, it is however currently preferred to use MPEG-4 encoded files, such as H.264 encoded files, or Flash Video files (.flv).

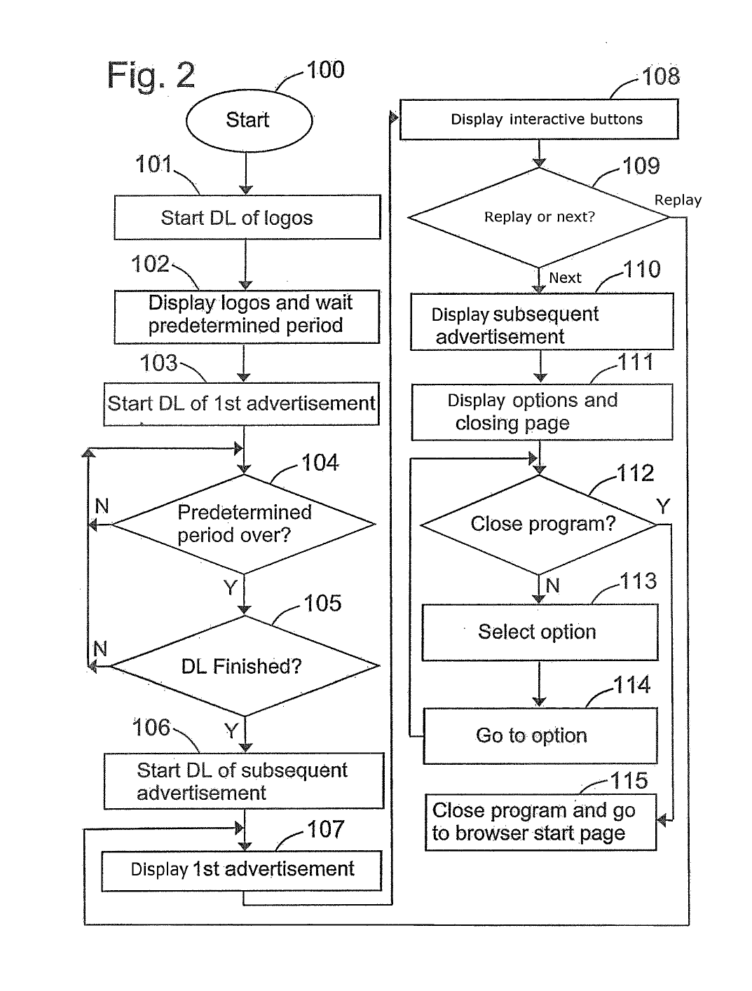

FIG. 2 shows the general operation of the advertising software, when installed on a computer 2. That is to say that initial download of the advertising software and installation thereof on the computer 2 has already been made, and that in that connection the selection of preferences such as preferred categories for advertisements and the designation of an account for receiving remuneration has already been made.

The execution of the advertising software starts in 100 by user action triggering an event, e.g. by the user clicking on an icon displayed on a graphical user interface on the user's computer display.

The advertising software is built to comprise various functional modes.

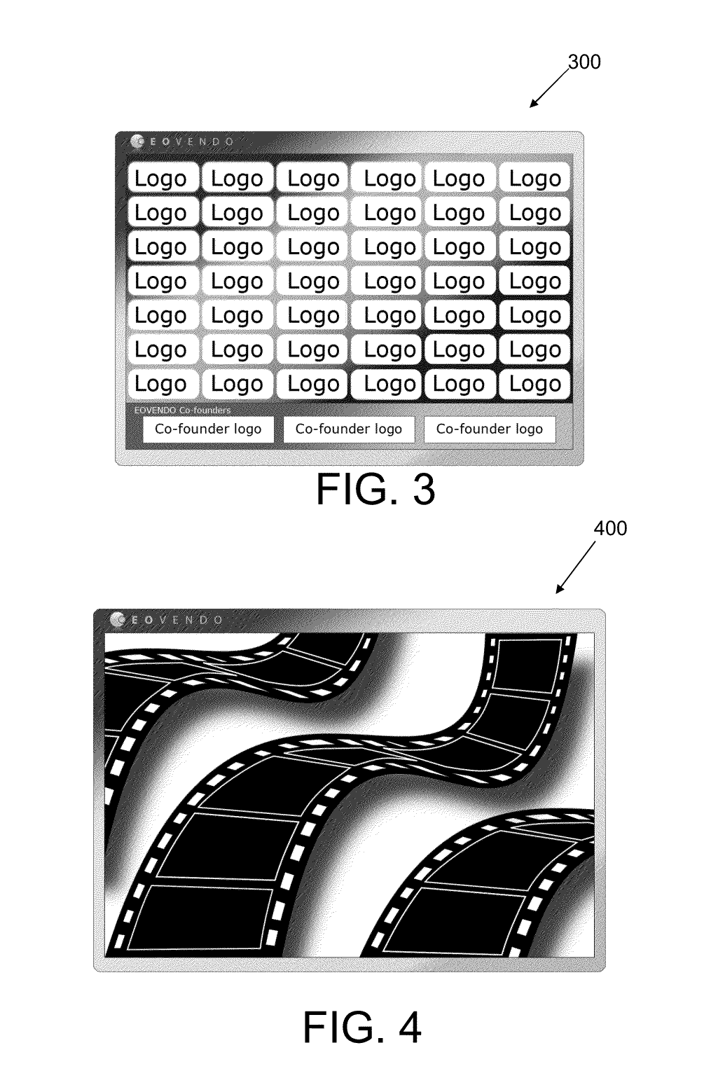

One functional mode is that the software runs actively on the computing device with an open window displayed to the user. In this mode, the launch of the program in box 101 starts with downloading a number of brand logos to be displayed as a number of still advertisements on an opening screen 300 in box 102, as illustrated in FIG. 3. A screen is a preferred visual output from the computing device. Preferably, in box 102, the opening screen 300 is not displayed until all logos have been downloaded, in order not to give the user an impression of waiting. FIG. 3 illustrate that one advertiser may pay for several logos on the same screen and have them grouped together in various ways for maximum effect. Meanwhile, an optional splash screen with information about the advertising software could be presented in order to reassure the user that the software has been properly launched. However, in order to allow acceptable download times for the image advertisements the software is intended to be used with high speed Internet connections only, and the download time for the logos is usually negligible. A splash screen is thus only an option, which could be dispensed with.

The download time for multimedia such as a 30 second high resolution moving image advertisement is however not negligible. Thus, immediately after the start of the display of the logos in box 102 and preferably immediately after the download thereof, the advertising software proceeds to box 103 and starts downloading the first image advertisement to be displayed subsequent to the logo being displayed. Apart from the advertising value, the main purpose of the display of the logos in box 102 is to occupy the attention of the user during the download time for the first image advertisement. Thus, in decision box 104 it is checked whether a predetermined display period for the opening screen has expired. With the current speed of Internet connections it has been found that displaying the opening screen for 9 seconds suffices to buffer enough of the image advertisement to allow it to play uninterrupted for a 30 second duration. If the Internet connection speed is known or turns out to be insufficient for the image advertisement to play uninterrupted for the duration, it may be necessary to buffer more of it or even download the image advertisement in its entirety. In this case, it is in an optional step, box 105, checked whether a sufficient part, e.g. as illustrated the entire image advertisement, has been downloaded, before proceeding to display the image advertisement in box 107. The term download herein may also be streaming of image advertisements.

FIG. 4 shows an example of a display screen 400 displaying an image advertisement. After the entire first image advertisement has been downloaded, the download of the subsequent image advertisement starts. In the illustrated example where an entire image advertisement is buffered before display, this subsequent download starts in box 106 immediately before (as illustrated) or at virtually the same time as the display starts in box 107, thus allowing the subsequent image advertisement to be downloaded during the display of the first image advertisement. The skilled person will however understand that the download of the subsequent second image advertisement may start at any time after the completion of the download of the first image advertisement, i.e. even if that one is still being displayed.

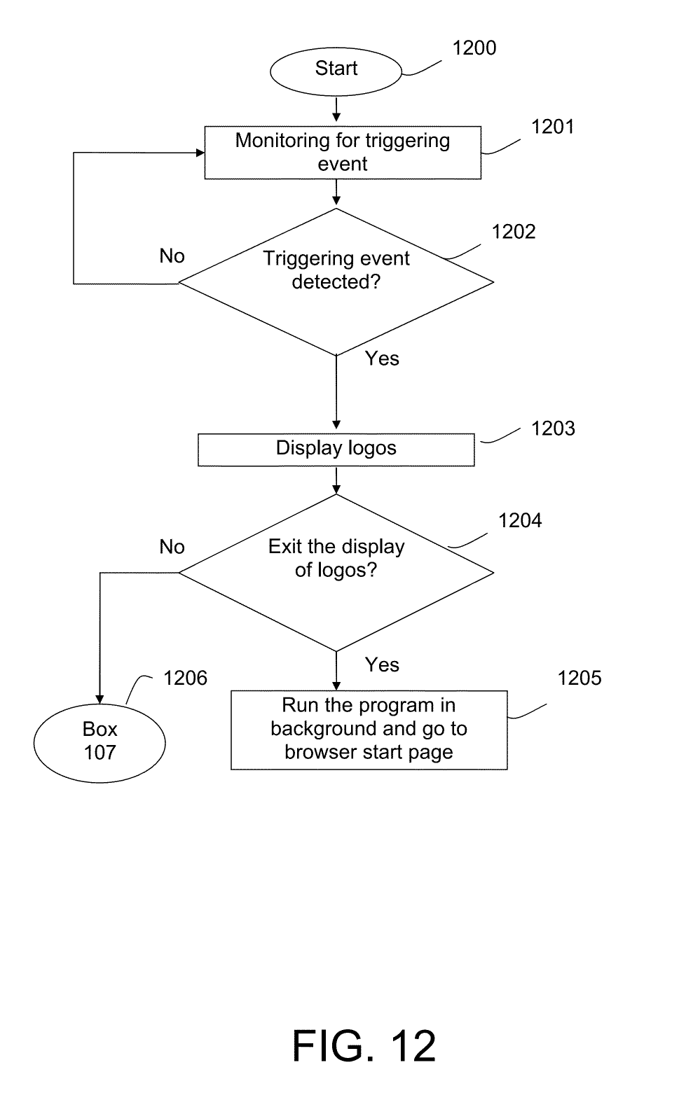

Another functional mode is that the advertising software runs in the background without displaying any open window. This mode is illustrated in FIG. 12 and starts in box 1200. In this mode, the image advertisements (e.g. logos, moving image advertisements) are downloaded in the background on the computing client device while the user performs other activities on the computing client device. Once the image advertisements are downloaded and ready to display corresponding to box 1200 in FIG. 12, the advertising software proceeds to box 1201 where it is set to monitor for a triggering event such as when the user accesses the browser software. Upon the detection of the triggering event by the advertising software in box 1202, the advertising software proceeds to box 1203 and launches the display of logos that the user can choose to exit in box 1204. If the user chooses to exit the display offered by the advertising software, the advertising software proceeds to box 1205 where the start page of the browser is displayed to the user and the advertising software continues to run in the background. If the user chooses to view the logos and the subsequent image advertisements, the advertising software runs as in the active mode from box 107 of FIG. 2.

Also in the background mode, after downloading successfully the image advertisements, the advertising software also informs the user in a display interface that advertisements are ready to be displayed. If the user clicks on the interface displayed on the graphical user interface, the advertising software starts displaying the logos and follows FIG. 2 from box 107.

The image advertisements, i.e. the multimedia files, may be downloaded from a central server, e.g. the server 4 to each of the clients 2. It is however preferred that the multimedia are to a large extent distributed directly between the users. Preferably this is done using a peer-to-peer technology such as BitTorrent, where the server 4 initially supplies the multimedia files, and subsequently keeps track of which clients computers 2 stores which files, allowing them to be distributed directly between the client computers 2. Using BitTorrent technology furthermore allows different parts of a multimedia file to be supplied from different uploading client computers 2 to the downloading client computer 2. Hence, different pieces of the same file may be downloaded from various available sources, i.e. client computers 2, thus distributing the load on the Internet and relieving the load on the server 4.

Moreover the use of BitTorrent technology could obviate the need for a central server 4 for storing the files initially. Instead the providers of the image advertisement could themselves distribute the films initially, uploading only tracking information to the server 4.

To further decrease the load on the server 4, it is envisaged that some users of client computers 2 could be remunerated for storing the entire multimedia files for an extended time period for the distribution to others.

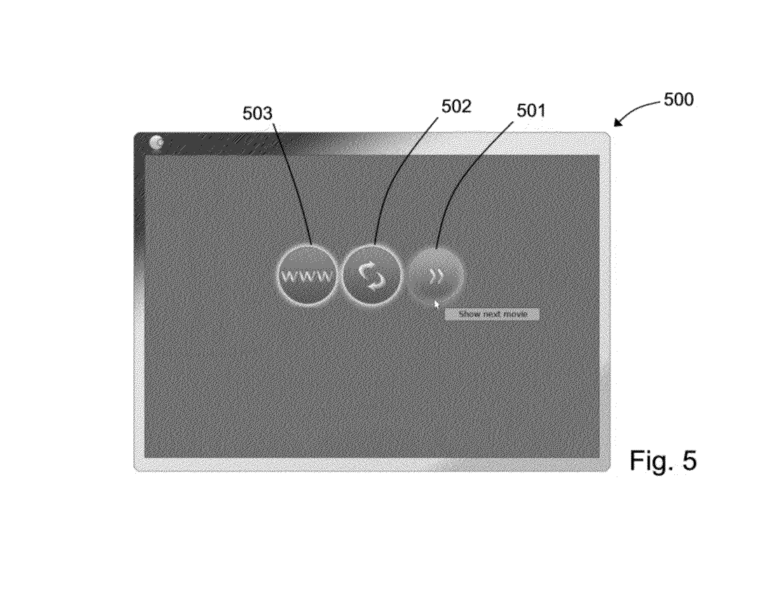

After the first image advertisement has been displayed interactive elements such as virtual buttons 500 on the screen as illustrated in FIG. 5 are displayed in box 108. The virtual buttons allow the user the choice in box 109 between watching the image advertisement again for pleasure—preferably not for additional remuneration, or watching the subsequent image advertisement for remuneration in box 110. The main purpose of the virtual buttons is however not the choice. Rather, the virtual buttons are presented in order to prompt a user feedback input from the user, thus verifying that the user has actually watched the image advertisement. Preferably, the choice between replay or subsequent image advertisement should take place within a predetermined time after the screen has been displayed, i.e. to ensure that the user actually stayed in place in front of the screen during the display of the image advertisement. A duration of the predetermined time of less than 10 seconds is currently preferred. The likelihood that the user actually did watch the image advertisement for which the user is remunerated is increased. In this respect it should also be noted that the advertising software is designed to always run in the foreground of a multitasking desktop environment when image advertisements are displayed. In this way it is ensured that the user does not simply minimize the window in which the software is running or displays another program interface in front of it during the display of the image advertisements.

For the user feedback input a number of interactive buttons are provided on the graphical user interface as illustrated in FIG. 5. Here, pressing the button 501 will initiate the display of the next image advertisement, i.e. proceeding to box 110, whereas pressing button 502 will initiate a replay of the last image advertisement displayed, i.e. returning to box 107. Note that the various interactive buttons are placed pseudo-randomly on the graphical user interface after the display of an advertisement to counter-strike potential cheaters. Moreover, pressing the button will send information to the server 4 that the image advertisement has been watched. The server 4 registers the watching and makes the necessary provisions for crediting the user's account. In this respect it should be noted that in order to limit the amount of remuneration obtainable the number of installations of the advertising software on a single computer is preferably limited to one. An installation for each user could however be envisaged in a multiuser environment. Also, the server keeps track of the number of image advertisements displayed, and restricts the overall number of image advertisements displayable. In this respect it is currently preferred to limit the number of displayable image advertisements to three in a two hour time period. If this number is reached and the time period has not expired, the server 4 communicates this to the advertising software, which then automatically ends the display of image advertisements and starts the user's browser, i.e. goes to box 115.

As illustrated by the button 503 the user may also be given other options, e.g. downloading in the background an advertisement page relating to the image advertisement just watched, e.g. for further information or purchase. Though less preferred there could as an alternative or in addition be an option of quitting the advertising software and go directly to the World Wide Web without display of any further image advertisements, i.e. going to box 115.

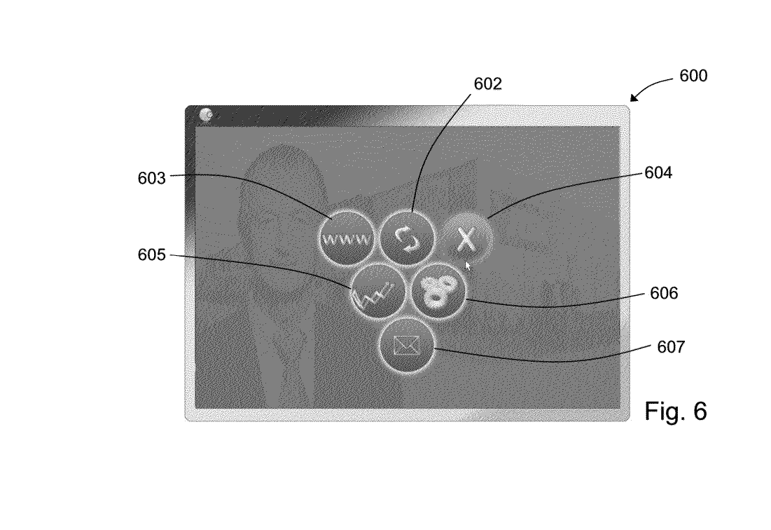

The steps of boxes 106 to 110 may be repeated as often as desired without deviating from the scope of invention. It is however currently preferred to repeat only once, the number of image advertisements displayed and watched by the user thus totaling three, before reaching, in box 111, a closing and options screen illustrated in FIG. 6.

Like the replay screen 500, the closing and options screen 600 is presented in order to prompt a user feedback input from the user, thus verifying that the user has actually watched the image advertisement. Buttons 602 and 603 would correspond to buttons 502 and 503 of FIG. 5, respectively. However, because the closing and options screen 600 is the last screen to be displayed, it involves a larger number of buttons. Thus a closing button 604 is provided. If this button is pressed the execution of the advertising software proceeds to box 115, upon which the advertising software allows the access to the World Wide Web, e.g. by starting the user's browser and closing itself.

A button 605 is provided for allowing the user to see the statistics of the user's use of the software, in particular the remuneration received. A button 606 is provided for entering the setup allowing the user to change the user's preferences if they have changed. As an example, if a user has an interest in advertisements relating to automobiles because the user wants to buy a new one, this interest is likely to drop just after the user has actually bought one.

Pressing one of these buttons represents selection of an option in box 113 of FIG. 2, upon which, in box 114, the software proceeds to the software parts relating to the specific option.

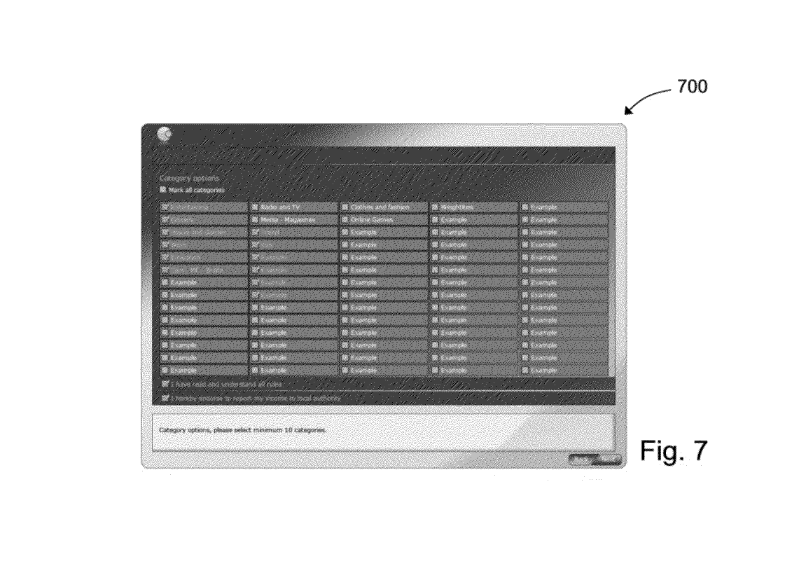

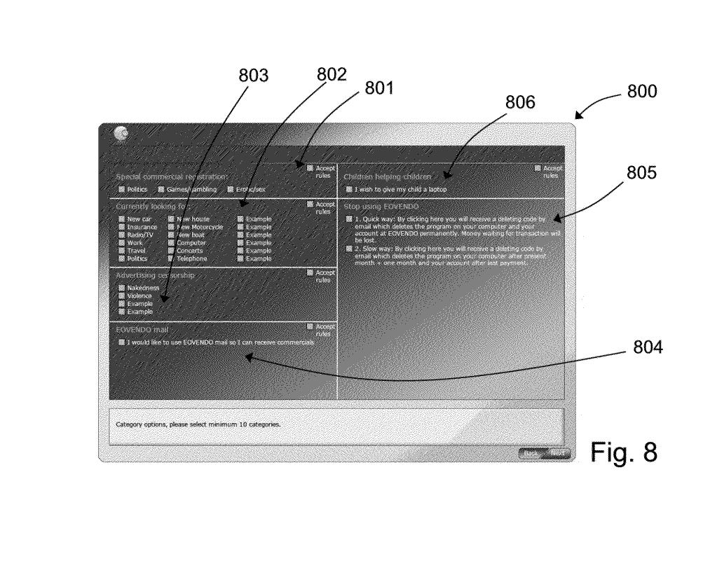

These options are not all of relevance for the present invention and numerous other options can be thought of. These options will not all be dealt with here. However, pressing button 606 will send the user through a number of selection and options pages illustrated in FIGS. 7 and 8. These pages essentially correspond to pages, which the user will also have to go through in the user's initial installation and registering of the advertising software. Thus, FIG. 7 illustrates a selection screen where a number of different categories of advertisements is listed and the user is required to select a number of them, so as to ensure targeted advertising. It is currently preferred that the user should select at least ten categories, but different numbers could apply, depending on the number of available categories or the degree to which they are detailed. FIG. 8 illustrates a further selection screen 800. This selection screen 800 is subdivided into several groups. The group 801 comprises selections relating to sensitive material such as erotics, gambling, alcoholic beverages etc. where the user has to have a certain age and where the user's explicit consent to watch the advertisements is demanded. The group 802 represents categories where the user has an increased interest in the products, because the user is actively interested in them, e.g. currently looking for a new car or real estate. The group 803 again relates to sensitive material, where the user has to actively give the user's consent in order to protect users in general from advertisements, which might offend them, such as advertisements depicting nakedness or violence. The field 804 allows the user to sign in to receive advertising brochures in electronic form in a specific mailbox. Signing in to use the mailbox will activate the mailbox option accessible via the button 607 in FIG. 6, as will be described further below. The field 805 allows the user to stop using the advertising software and settling the user's account in various ways.

Field 806 represents a further inventive aspect of the invention, helping children around the world and aiding in the proliferation of the advertising software. If the user ticks this box, the user may indicate the wish to donate a computer to a child, be it the user's own offspring or a needing child in the neighborhood or at a local school. This option is preferably only available for loyal users who have used the advertising software on a regular basis for an extended period of time. The computer will be supplied to the desired child with the advertising software preinstalled in a locked manner, allowing access to the Internet via the advertising software only. Various different schemes for financing the computer may be envisaged. The currently preferred way would allow the provider of the advertising software to donate the computer, and thus gaining a further user. Another way would allow the donator to pay for the computer using the user's earned remuneration. A third way would allow the computer manufacturer to donate the computer, e.g. against free advertising time using the advertising software.

The advertising software allows the user to retrieve the credits that the user earned as money or to use them to pay services such as Internet services, mobile communication services or to obtain gift cards for goods, vacations, and other types of credit conversion.

Returning now to the mailbox option, as briefly indicated above, the advertising software has an integrated advertising mailbox for receiving advertising brochures. Retailers may distribute printed brochures to people's physical mailboxes on a weekly, bi-weekly or monthly basis in order to inform about special offers to attract costumers. Very many of these retailers also publish electronic versions of the printed brochures on the Internet, and some even allow people to subscribe to email delivery of them.

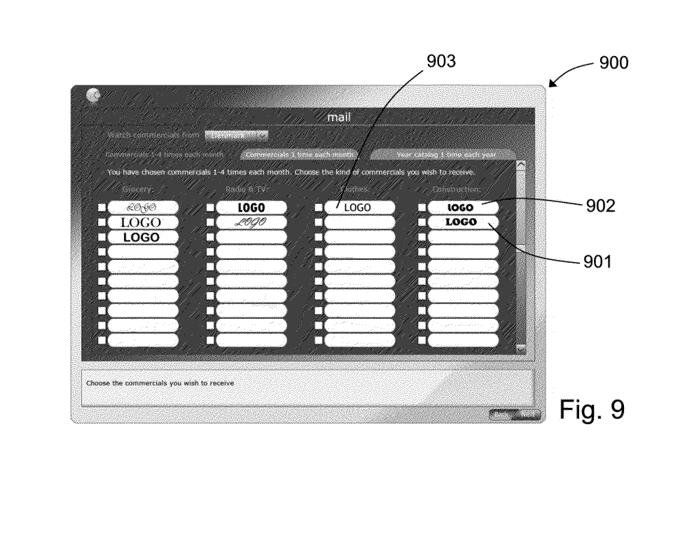

By using the mailbox option of the advertising software the user would automatically receive electronic versions of the brochures from various retailers, depending on the user's selection. Thus the user would not need to actively look for them at the retailers Internet site, risk to overlook them in the user's email inbox, or overlook the printed brochure in the user's physical mailbox. These electronic brochures would then automatically be downloaded and updated in the background while the user is watching the last image advertisement. FIG. 9 show as selection 900 screen allowing the user to select advertisements from various retailers by clicking appropriate buttons 901, 902.

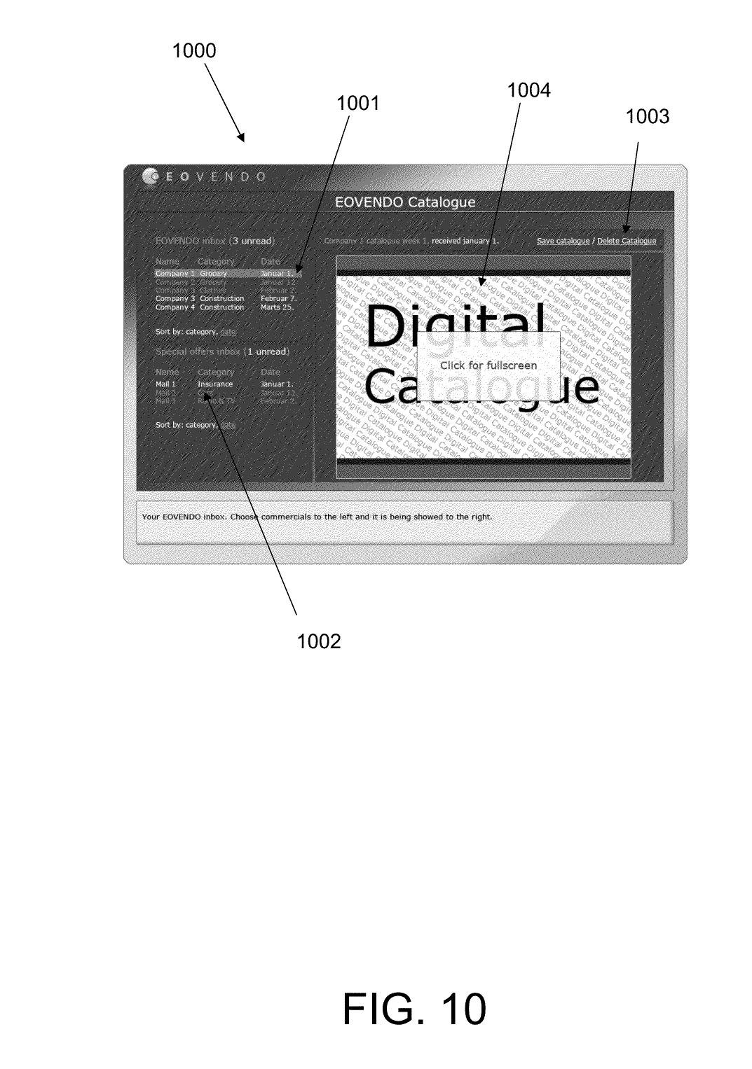

FIG. 10 shows the in-box screen 1000. At the left-hand side of the screen the brochures, which have been downloaded to the mailbox, are listed. As shown, the mailbox screen 1000 comprises there are two different in-boxes, one in-box 1001 for the regular, e.g. weekly, brochures and one in-box 1002 for extra issues, such as special offer or campaign issues. The user may select any brochure listed and it is then displayed in a window 1004 on the right-hand side of the screen. As indicated the mailbox may comprise a full screen display mode so as to allow the user to better read the brochure. The in-box screen further has means 1003 for the user to delete a selected brochure, e.g. after having read it. Older brochures may of course also be deleted automatically by the advertising software.

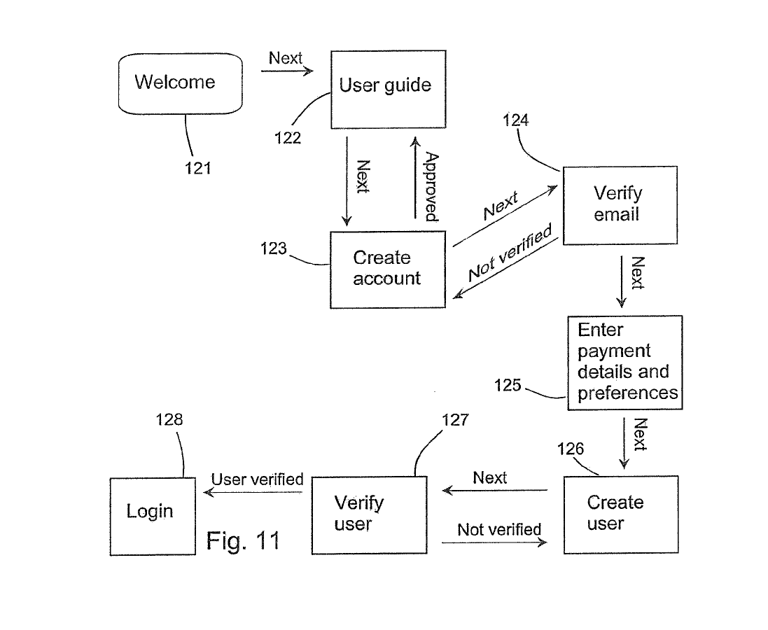

Having described the general operation of the advertising software, an example of download and initialization will now be described, with reference to FIG. 11. Before the user can use the advertising software for the first time an initialization process must be carried out in order to secure the necessary data about the user, such as an account for payment, contact details, preferences with regard to advertising etc. Some or most of this initialization may take part before the user is allowed to download the advertising software in the first instance. Alternatively it may form a part of the process of installing the software after download thereof or it may be carried out during first run of the installed advertising software. FIG. 11 illustrates an example of installing the software during first run of the installed advertising software. Starting the advertising software for the first time the user receives a welcoming message in box 121. The user is then directed to a user guide in box 122. In the user guide the user is prompted to create an account if the user does not already have one. This account, which is created, in box 123, is preferably an account provided by third party such as PayPal™ rather than account set up by the provider of the advertisement software. When the user has created an account, the user submits an email address as the user's unique identification. The email address is verified in box 124, e.g. by sending the user a link via the submitted email. If the recipient of the email approves the use of the email address by clicking on the link, the email is verified. If the email cannot be verified the process returns to box 123, where the user is prompted to resubmit it (or another valid one). When the user has submitted a valid email address, this will allow the user to enter the necessary details, in box 125, such as payment details, and preferences for advertisement messages. The user is then created locally in box 126 and the relevant details sent to the server 4 so that the user can be verified in box 127 for this and future sessions. If the user is verified an automatic login is performed in box 128 and the normal operation of the advertising software as described above with reference to FIG. 2 starts.

In a further aspect, the invention provides an advertiser system. An advertiser is a person who wants to carry out advertisement campaigns and distribute advertisements to an audience of users. The advertiser system allows an advertiser to register in the system and to create and manage a campaign.

In the advertiser system, the registration of an advertiser can be performed as follows:
the advertiser uses a browser to connect to the publishing website of the advertiser system.
The advertiser registers on the publishing website by providing company information (e.g. Name, Location, Telephone Number and company registration Number), Options (e.g. Contact Person Information) and a login with a password. The login and password are subsequently used to authorize the advertiser to access their campaigns on the publishing website.

In the present advertiser system, after registration the advertiser creates a campaign in the following way. The creation procedure comprises:
The advertiser selects the type of campaigns the user would like to create among various types such as movie campaign, logo campaign, mail campaign, and catalogue campaign.
The advertiser uploads the media advertisement (e.g. image, movie, catalogue) that is to be used in the campaigns.
The advertiser indicates one or more categories and sub-categories of the uploaded advertisement. Such categories can be general categories such as grocery, clothes, cars but also categories related to censorship such as nudity, violence, gambling, alcoholic beverages.
The advertiser selects demographics (e.g. age, age range, gender, personal status, financial capability, and profession) and location information (e.g. country, region, and postal code) of targeted viewers.
The advertiser enters a timing for the uploaded advertisement to be distributed to targeted viewers which is a lifetime/advertising period, a priority of distribution over the lifetime period, a distribution frequency per time unit of the lifetime period and any combination thereof. The advertiser can select to show the advertisement as quickly as possible or to equally divide the views on the current advertising period. The latter function takes the amount of views and divides them on the amount of days in the advertising period, so the campaign has a selected numbers of views per day.

The advertiser system provides the advertiser with a summary of the created campaign with a cost. The advertiser can then proceed to the payment of the cost of the campaign through a third party such as PayPal, via credit card, bank transfer or check, or any other means of remote payment.

The advertiser system provides also the advertiser with statistical information related to viewers of the uploaded image advertisement. The statistical information related to viewers of the uploaded image advertisement is a number of views, a number of viewer clicks, a metric relating the number of views to the number of clicks, and/or geographical information of the viewers.

The advertiser system further provides a working area for the advertiser to monitor their campaigns. The working area is a web page with tabs that group information about campaigns, price, payment and statistics. The working area allows the advertiser to view and manage their campaigns.

The advertising system and the advertiser system are both managed by an administration system that monitors the advertising activity: activity of the advertisers and of the viewers. The administration system comprises content moderation, screening of the advertisement for censored matters, monitoring of viewer behavior (time to click after viewing, number of views per viewer, average income per month and so on).

The above description was given based on preferred exemplary embodiment of the invention, and should not be considered limiting the scope of the invention. The skilled person will realize that numerous variations and modifications of the examples are possible without deviating from the scope of invention as set out in the appended claims.

1. (canceled)

2. A system for advertising based on user-relevant categories of advertisements, said system comprising:
a client computing device having electronic communication network connectivity and at least one display for visual output from the computing device,
a browser constituting part of said system and configured to be executed on said client computing device for accessing content on a communication network,
an advertising software constituting part of said system and adapted to run on said client computing device for accessing advertisements,
said advertising software configured for a user to indicate preferred categories of advertisements,
said advertising software configured for downloading at least a part of one or more multimedia files comprising one or more image advertisements in accordance with said user-relevant categories,
said advertising software being adapted to display at least a part of one of said one or more multimedia files as an image advertisement on the display, wherein
said advertising software furthermore comprises a means for detecting a triggering event initiated by the user activating a user input interface of the client computing device, wherein the triggering event is the user's access to the browser software,
said advertising software allowing the user to choose whether or not to display at least a part of one of the at least partly downloaded one or more image advertisements, upon detection of the triggering event,
with the proviso that the user, after having been allowed to choose, has chosen to display at least a part of one of the at least partly downloaded image advertisements; and,
said advertising software being adapted to block access for said browser software to content on a communication network as long as it is displaying at least a part of said at least one multimedia file.

3. The system according to claim 2, wherein said triggering event is a start of said advertising software on the computing device.

4. The system according to claim 2, wherein said advertising software is adapted to allow the user to choose to display at least a part of one of the at least partly downloaded image advertisements amongst advertisements most recently downloaded, upon detection of the triggering event.

5. The system according to claim 2, wherein said advertising software is adapted to allow the user to choose to display at least a part of one of the at least partly downloaded image advertisements amongst advertisements being rated as the best by a plurality of users, upon detection of the triggering event.

6. The system according to claim 2, wherein said advertising software is adapted to allow the user to choose to display at least a part of one of the at least partly downloaded image advertisements amongst advertisements being the most viewed by a plurality of users, upon detection of the triggering event.

7. The system according to claim 2, wherein said advertising software is adapted to upload the downloaded multimedia files to other client computing devices.

8. The system according to claim 2, wherein said software comprises a means for registering information about the upload of multimedia files, a means for communicating said information to a server, said server comprising a means for effecting remuneration of a person identified as the user of the software.

9. The system according to claim 2, wherein said advertising software is adapted to stream at least a part of one or more multimedia files comprising image advertisements in accordance with said user-relevant categories.

10. The system according to claim 2, wherein said advertising software further comprises a mailbox adapted for receiving and displaying electronic advertisement brochures.

11. The system according to claim 2, wherein at least one still image advertisement is downloaded and subsequently displayed during the download of at least a part of one moving image advertisement to be displayed.

12. The system according to claim 11, wherein none of the still image advertisements are displayed until all the still image advertisements have been downloaded.

13. The system according to claim 2, wherein said advertising software displays at least a part of said multimedia files as image advertisements on the screen in a temporal sequence, the displaying of the next image advertisement being contingent to user input action within a certain time limit after the preceding image advertisement is finished.

14. The system according to claim 2, having a means for allowing only a predetermined number of image advertisements to be displayed within a given time period.

15. The system according to claim 2, wherein said software comprises a control means for confirming that the user has viewed the image advertisement.

16. The system according to claim 15, wherein said control means comprises
at least one user feedback element displayed on the visual output and to be activated by the user within a certain time limit after the display of the image advertisement is finished to confirm the user's viewing of the image advertisement, and
a means for pseudo-randomly placing the at least one user feedback element on the visual output at the end of the display of an image advertisement.

17. The system according to claim 2, wherein said advertising software comprises a means for offering to redirect the user to a website corresponding to the at least one viewed image advertisement.

18. The system according to claim 2, wherein said advertising software comprises a means for registering information about the display of said image advertisements, including confirmation of the user's viewing of said image advertisements, means for communicating said information to a server, said server comprising means for effecting remuneration of a person identified as the user of the software.

19. The system according to claim 18, wherein said advertising software comprises a means for allowing the user to convert the remuneration into at least one of the following financial contributions: a service offered by a service provider to the user, and a donation offered by the user to others.

20. The system according to claim 2, wherein the computing device is selected from the group consisting of a personal computer, a gaming console, a personal digital assistant, and a cellular phone.

21. A method of displaying content of a multimedia file on a computer device, said computer device comprising a browser, said multimedia file having a set of categories and said displaying is based on selection via user-relevant categories, said method comprising:
obtaining information about user-relevant categories,
selecting and downloading at least a part of at least one multimedia file to said computer device, said at least one multimedia file comprising at least one image advertisement in accordance with said user-relevant categories,
detecting a triggering event initiated by the user activating a user input interface of the client computing device, said triggering event being access of said browser,
upon detection of the triggering event, allowing the user to choose whether or not to display at least a part of the at least one image advertisement,
displaying on visual output the at least a part of the at least one image advertisement if the user has chosen the at least one image advertisement to be displayed, and
temporarily blocking access to content on a communication network via said browser as long as the at least a part of the at least one image advertisement is displayed.

22. The method according to claim 21, wherein access by said computing device to said browser is blocked, when the triggering event is detected.

23. The method according to claim 21, wherein said triggering event is a start of said browser on the computing device.

24. The method according to claim 21, wherein said triggering event is a start of said advertising software on the computing device.

25. The method according to claim 21, wherein a number of still image advertisements are downloaded and subsequently displayed during the download of at least a part of a first image advertisement to be displayed.

26. The method according to claim 25, wherein none of the still image advertisements are displayed until all the still image advertisements have been downloaded.

27. The method according to claim 21, wherein said multimedia files are at least partly displayed as image advertisements in a temporal sequence, the displaying of the next image advertisement being contingent to user input action within a certain time limit after the preceding image advertisement is finished.

28. The method according to claim 21, wherein only a predetermined number of image advertisements are displayed within a given time period.

29. The method according to claim 21, said method comprising the step of confirming that the user has viewed the image advertisement.

30. The method according to claim 29, wherein at least one user feedback element is pseudo-randomly placed on the visual output, and wherein the at least one user feedback element, at the end of the display of an image advertisement, is activated by the user within a certain time limit after the display of the image advertisement is finished, said feedback element registering the user's viewing of the image advertisement.

31. The method according to claim 21, wherein the user is redirected to a website corresponding to the at least one viewed image advertisement.

32. The method according to claim 21, wherein information is registered about the display of said image advertisements, said information including confirmation of the user's viewing of said image advertisements, and wherein said information is communicated to a server, said server effecting remuneration for viewing the advertisements of a person identified as the user of the software.

33. The method according to claim 32, wherein the user converts the remuneration into at least one of the following financial contributions: a service offered by a service provider to the user, and a donation offered by the user to others.

34. A system for advertisers to display advertisements on a visual output of a client computing device to a user of the client computing device, said system comprising:
the client computing device having electronic network connectivity and at least one display for visual output from the computing device,
a browser software constituting part of said system and adapted to run on said client computing device for accessing content on a communication network,
a server device having network connectivity and accessible from a communication network,
an advertiser software constituting part of said system and adapted to run on said server device,
said advertiser software allowing an advertiser to upload at least one multimedia file comprising image advertisements,
said advertiser software allowing an advertiser to indicate at least one category of the uploaded image advertisement,
said advertiser software allowing an advertiser to select demographics and location information of targeted viewers,
said advertiser software allowing an advertiser to enter a timing for uploaded advertisement to be distributed to targeted viewers, and
said advertiser software providing an advertiser with statistical information related to viewers of the uploaded image advertisement.

35. The system according to claim 34, wherein the demographics of targeted viewers comprise age, age range, gender, personal status, financial capability, or profession.

36. The system according to claim 34, wherein the location information of targeted viewers comprises country, region, and postal code.

37. The system according to claim 34, wherein the timing for uploaded advertisement to be distributed to targeted viewers is a lifetime period, a priority of distribution over the said period, or a distribution frequency per time unit of the said period or any combination thereof.

38. The system according to claim 34, wherein the statistical information related to viewers of the uploaded image advertisement comprises number of views, number of viewer clicks, a metric relating the number of views to the number of clicks, or geographical information of the viewers.
